(19) United States
(12) Patent Application Publication
(10) Pub. No.: US 2021/0150052 A1
(43) Pub. Date: May 20, 2021

(54) COLLECTING, DISPLAYING, AND/OR STORING INFORMATION PERTAINING TO CONSENT

(71) Applicant: salesforce.com, inc., San Francisco, CA (US)

(72) Inventor: Stephan Garcia, Surrey (GB)

(73) Assignee: salesforce.com, inc., San Francisco, CA (US)

(21) Appl. No.: 16/778,824

(22) Filed: Jan. 31, 2020

Related U.S. Application Data
(60) Provisional application No. 62/937,102, filed on Nov. 18, 2019.

(51) Int. Cl. G06F 21/62; G06Q 50/18

(52) U.S. Cl. CPC G06F 21/6245; G06Q 50/18; G06F 21/6227

(57) ABSTRACT

Implementations are described which collect and display through a graphical user interface information pertaining to consent of a person. Information is collected in an order according to legal basis, purpose, type of action, and consent. One or more records that store legal bases for consent are retrieved. A user's selection of a legal basis is accepted. One or more records that store purposes for the legal basis are retrieved. A user's selections of a purpose, a type of action, and a consent value are accepted. Less than all the information is displayed. The user's selection of another type of action is selected. Based on that type of action, a purpose and an indication of a consent value for combinations in a database are displayed.

### CROSS-REFERENCE TO RELATED APPLICATIONS

This application claims the benefit of U.S. Provisional Application No. 62/937,102, filed on Nov. 18, 2019, which is hereby incorporated by reference.

### TECHNICAL FIELD

One or more implementations relate to the field of processing consent information relating to data privacy laws; and more specifically, to collecting, storing, and/or displaying information pertaining to consent in a database.

### BACKGROUND ART

Data privacy laws and are proliferating, especially in the area of consent. Data privacy laws and regulations may restrict, amongst other things, the collection, disclosure, and/or use of information pertaining to a person. Data privacy laws may require a person's consent before an entity performs an action of a particular type relative to the person. In this context, a consent value is an electronic record of a person's manifestation of consent to an act, such as a record of a person's assent to being contacted for marketing purposes.

Typically, an entity will store consent values pertaining to a person in a database; specifically, one or more records may be associated with consent values, and those records stored in one or more database objects (DBOs). A database may comprise one or more database objects that are managed by a database management system (DBMS), each database object may include a set of records, and each record may comprise a set of fields. A record may take different forms based on the database model being used and/or the specific database object to which the record belongs; e.g., a record may be: 1) a row in a table of a relational database; 2) a JavaScript Object Notation (JSON) object; 3) an Extensible Markup Language (XML) document; 4) a key-value pair; etc. A database object can be unstructured or have a structure defined by the DBMS (a standard database object) and/or defined by a user (a custom database object). In some implementations of a cloud database (a database that runs on a cloud platform and that is provided as a database service), identifiers are used instead of database keys, and relationships are used instead of foreign keys.

Some tools allow for displaying information stored in a database in a generic way. For example, a tool might display a representation of a database in a graphical user interface; e.g., the database objects in the database, the fields and records of the database objects, and/or the values for the fields. Other tools might allow a user to store information in a database. For example, a tool such as a GUI wizard might display user interface (UI) elements in screens through which a user can navigate to provide information which is then stored in a database.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1A is a flow diagram showing methods for collecting and storing, and/or displaying, information pertaining to consent of a person, according to some exemplary implementations.

FIG. 1B is a flow diagram showing methods for collecting, storing, and/or displaying, information pertaining to consent of a person, according to some exemplary implementations.

FIG. 2A is a diagram showing a user interface element that allows for viewing and selecting from types of actions for a person, according to some exemplary implementations.

FIG. 2B is a more detailed diagram showing a user interface element that allows for viewing and selecting from types of actions for a person, according to some exemplary implementations.

FIG. 2C is a diagram showing a user interface element that allows a user to select a legal basis and a purpose for the selected legal basis, according to some exemplary implementations.

FIG. 2D is a diagram showing a user interface element that allows a user to select from types of actions for a selected purpose, according to some exemplary implementations.

FIG. 2E is a diagram showing a user interface element that allows a user to select a consent value for a combination of a person, a selected purpose, and a selected type of action, according to some exemplary implementations.

FIG. 2F is a diagram showing a user interface element that allows a user to provide information relating to how a selected consent value was obtained, according to some exemplary implementations.

FIG. 3A is a block diagram showing a database from which information pertaining to consent of a person can be retrieved, according to some exemplary implementations.

FIG. 3B is a block diagram showing a database in which information pertaining to consent of a person can be stored, according to some exemplary implementations.

FIG. 3C is a block diagram showing another database in which information pertaining to consent of a person can be stored, and/or from which such information can be retrieved, according to some exemplary implementations.

FIG. 4A is a block diagram illustrating an electronic device according to some exemplary implementations.

FIG. 4B is a block diagram of a deployment environment according to some exemplary implementations.

### DETAILED DESCRIPTION

The following description describes implementations for collecting and storing, and/or displaying, information pertaining to consent (also referred to as consent information) in a database.

Consent information can be classified in a hierarchy of consent values based on the granularity of the consent. One level of granularity may be a global opt-in or opt-out where opt-in means to consent and opt-out means not to consent (e.g., to deny consent). Another level of granularity may be consent to a particular type of action (also referred to as an action type), such as being contacted (e.g., via email, telephone, social media, etc.). Yet another level of granularity may be consent for a particular purpose (e.g., for solicitation, billing, receiving a newsletter, etc.). For a particular person, these levels of granularity can be conceived of as a hierarchy of consent values. Notably however, a hierarchy of consent values can have one, some, or all of these levels, and/or other levels of granularity. Moreover, different hierarchies may have different levels of granularity for the same type of consent. For example, consent to a particular type of action may be a coarser level of granularity than consent for a particular purpose in one hierarchy, and in in another hierarchy, a finer level of granularity than consent for a particular purpose.

A consent value at different ones of the levels of a hierarchy of consent values can be one of opt-in, opt-out, or other values (e.g., seen, indicating that the person was given reasonable notice that the person's consent is demanded (e.g., because a webpage that the person is browsing shows a pop-up window demanding the person's consent); unseen, indicating that the person was given notice but that the user may not have acknowledged the notice; unknown, indicating that the person has not provided an indication of consent or that such an indication is unavailable (e.g., due to technical reasons); etc.). A consent value might have a legal basis; e.g., relate to a person's conduct or a legal relationship. For example, a consent value might be related to a person's voluntary manifestation of consent (e.g., agreeing to receive a newsletter during a phone conversation) or a contractual relationship (e.g., consenting to receive billing statements because the person has contracted for goods or services). Consent can also be defined in terms of time. A person may provide consent or deny consent at one time, and at a later time deny consent or provide consent respectively. Additionally or alternatively, a person may provide consent or deny consent for a definite or indefinite period of time (e.g., for one week, one month, one year, the duration of a legal relationship, until consent is provided or revoked, etc.).

Additionally or alternatively, consent values can be expressed according to an order of information types. An information type can correspond to a type of action, a purpose, a legal basis, consent, etc. Thus, consent information can be expressed in an order of information types such as legal basis, purpose, type of action, and consent. Consent information may be collected, stored, and/or displayed according to an order of information types. For example, consent information for a particular person might be collected by identifying a legal basis for the consent, identifying a purpose (e.g., solicitation), identifying a type of action (e.g., email), and identifying consent (e.g., opt in). Consent information that is stored according to an order of information types might be retrieved in the same or in a different order of the same or different information types. For example, consent information that is collected according to an order of information types including legal basis, purpose, action, and consent value might be retrieved in an order of information types including action, purpose, and consent value. Collecting, storing, and/or displaying consent information according to different orders of information types can provide various advantages as described later herein.

Collecting, storing, and/or displaying consent information can be performed with different combinations of information types in the order of information types. For example, collecting consent information might include collecting a combination of a legal basis for the consent and a purpose for the consent (e.g., in one user interface element); storing consent information might include storing a combination of one or more of a type of action, a purpose, and/or a consent value (e.g., in one record of a database); and displaying consent information might include displaying a combination of a purpose and a consent value (e.g., in one user interface element). Collecting and/or displaying different combinations of information types can improve user experience and facilitate data entry or visualization, amongst other advantages. Storing different combinations of information types in a database can potentially reduce read and/or write times, reduce database size, improve datamodel cohesion, etc.

While implementations may use one or more types of databases, a relational database with tables is sometimes described to simplify understanding. In a relational database management system (RDBMS), each relational database table (which is a type of database object) generally contains one or more data categories logically arranged as columns according to a schema, where the columns of the relational database table are different ones of the fields from the plurality of records, and where rows of the relational database table are different ones of a plurality of records and each contains an instance of data for each category defined by the fields. Thus, the fields of a record are defined by the structure of the database object to which the field belongs. By way of example, a customer relationship management (CRM) database may include a table that describes a person (e.g., a contact or a lead) with fields for contact information such as name, address, phone number, etc. The database may also contain tables that store consent information for that person.

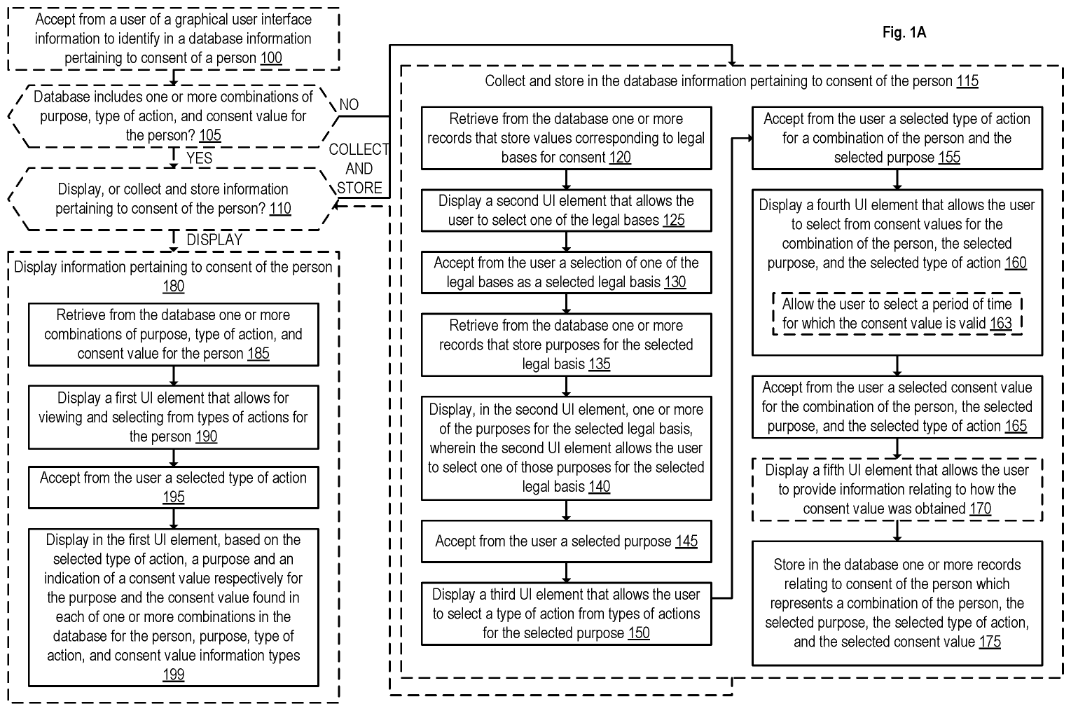

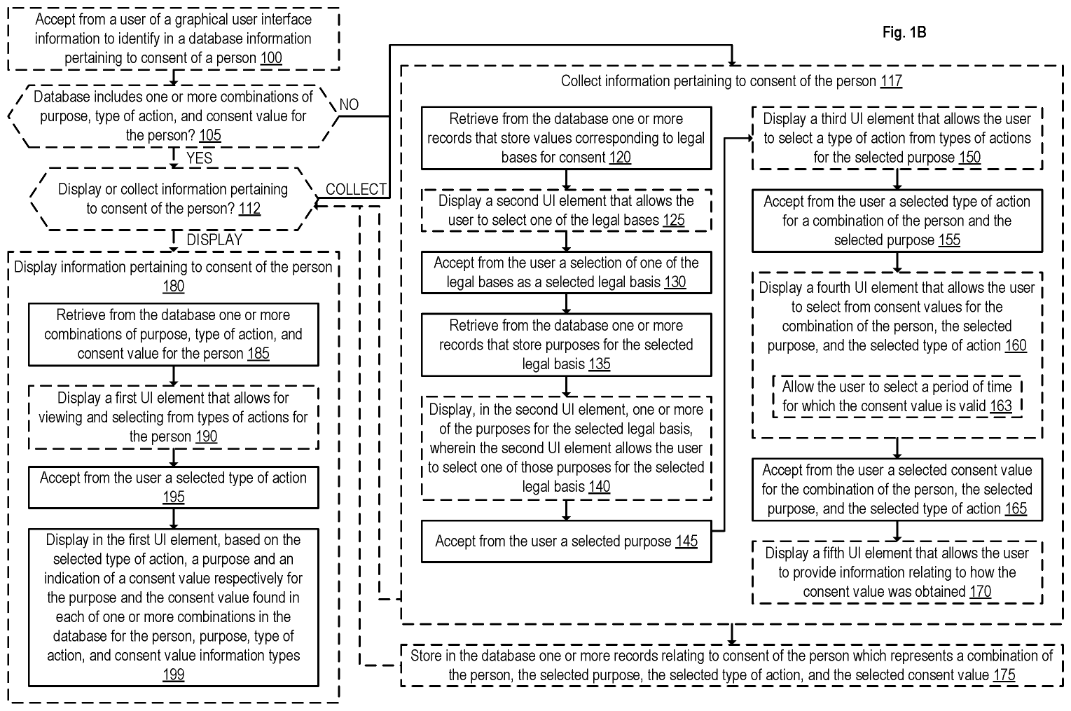

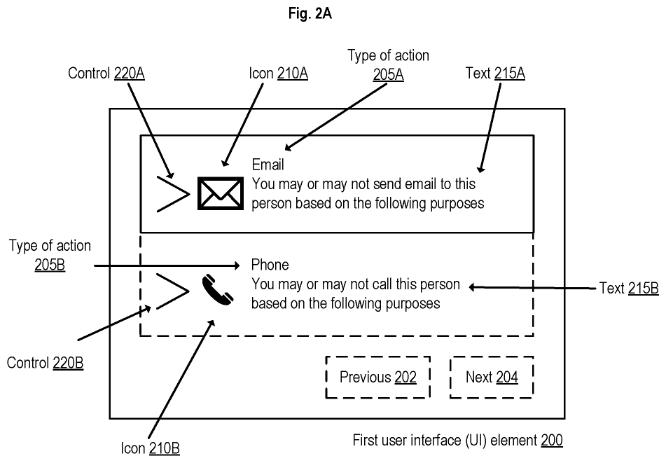

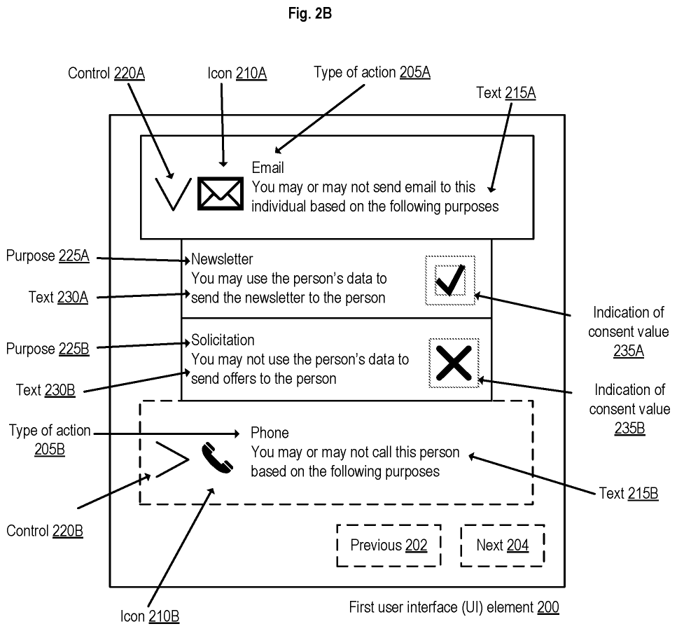

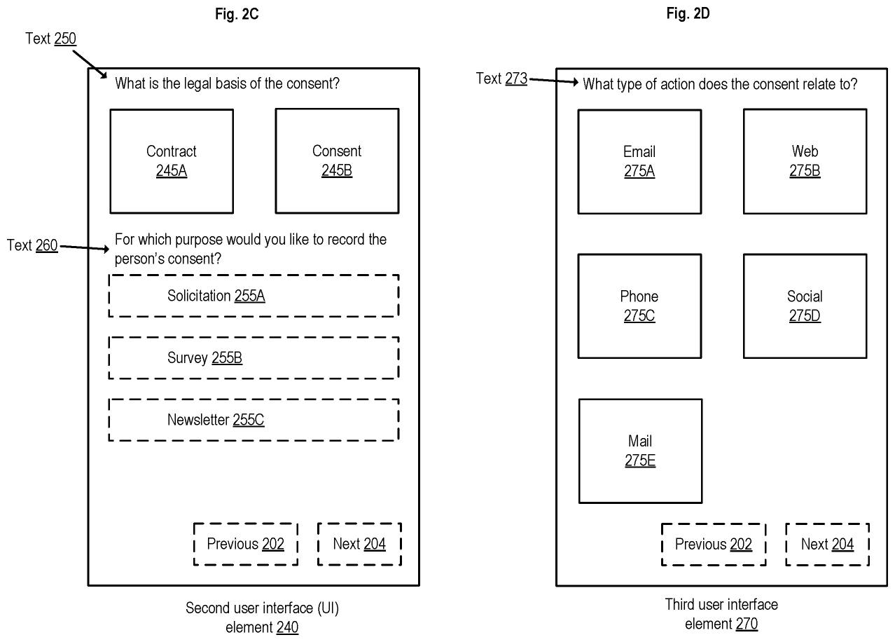

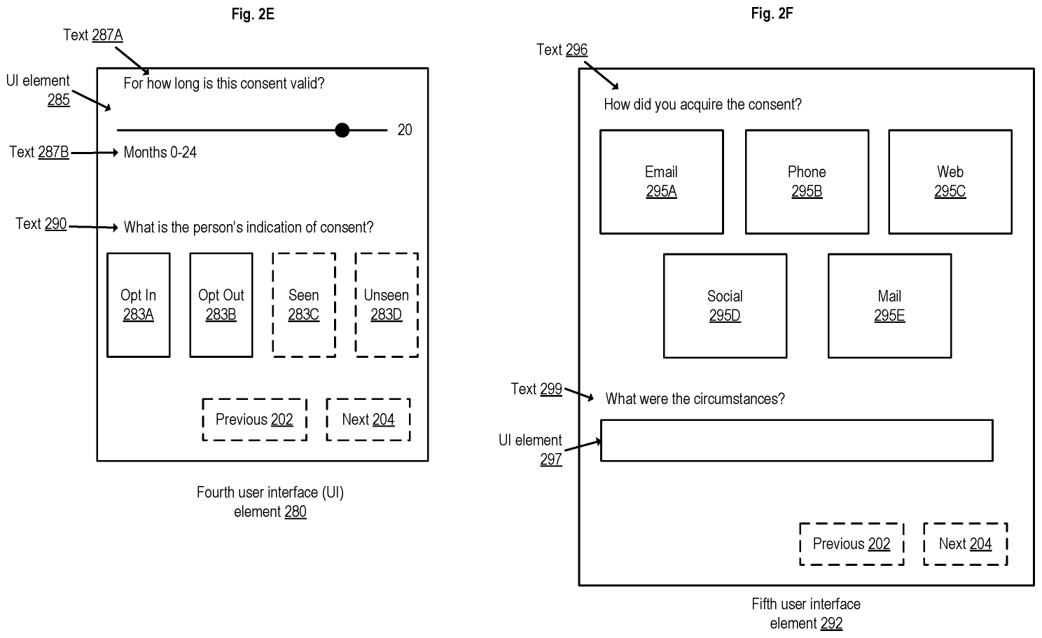

One or more of the methods described herein (e.g., one or more of displaying consent information pertaining to a person, collecting and storing consent information pertaining to a person, etc.) can be implemented using different forms of graphical user interface (GUI). For example, methods described herein can be implemented based on a GUI wizard. A GUI wizard is an ordered set of user interface (UI) elements (e.g., screens in a dialog, tabs in a screen, etc., each of which may include other UI elements) that allows a user to navigate between adjacent UI elements in the set; e.g., to guide a user in accomplishing a particular task. By way of example, a GUI wizard might guide a user in collecting and storing in a database information pertaining to consent of a person. Such a GUI wizard might include one or more of the UI elements described and/or shown in FIGS. 1A, 1B, 2C, 2D, 2E, and 2F, and/or other UI elements. As another example, another GUI wizard might guide a user in displaying information pertaining to consent of a person. Such a GUI wizard might include one or more UI elements that allow a user to provide information to identify consent information in a database, a UI element such as the UI element described and/or shown in FIG. 1A, FIG. 1B, FIG. 2A, FIG. 2B, and/or other UI elements. Yet another implement might include one or more of the UI elements described and/or shown in FIGS. 1A, 1B, 2A-2F, and/or other UI elements.

However, methods described herein need not be implemented with a GUI wizard and may be implemented using other forms of GUI. For example, methods can be implemented based on a single UI element (e.g., a screen, a panel, a webpage, a tab, etc.) that includes multiple other UI elements. For example, an implementation might include one or more of the UI elements shown or described in relation to FIGS. 1A, 1B, 2A-2F, and/or other UI elements, arranged on a single screen of a GUI. To guide a user in a corresponding method (e.g., collecting and storing consent information), the screen might be scrollable, highlight a next UI element for the user, etc. The forms of GUI mentioned are exemplary and not limiting, however. Methods described herein can be implemented using various different combinations of UI elements, and arrangements and configurations thereof, within the spirit and scope of the claims.

FIG. 1A is a flow diagram showing methods for collecting and storing, and/or displaying, information pertaining to consent of a person, according to some exemplary implementations. One or more implementations provide one or more of the methods described herein as part of a consent capture service.

In block 100, information to identify a person's consent information in a database is accepted from a user of a GUI. The user can provide the information in different ways. In one implementation, a user might provide the information directly; e.g., by entering information in a user interface (UI) element (e.g., a search field) to identify a person (e.g., by entering a name, a phone number, a social security number, etc.). In another implementation, a user might provide the information indirectly. For example, a user might select a link included in an entry for a person in an electronic address book (and the link provides information to identify a person's consent information), or select a UI element in the context of displaying a person's information (and the context provides information to identify the person's consent information). In some implementations, information to identify a person's consent information is information to identify the person (e.g., personally identifiable information). In other implementations, information to identify a person's consent information is an identifier (ID) for the person assigned by a system (e.g., a user ID in a CRM system, a record ID in a database, etc.). From block 100, flow passes to block 105.

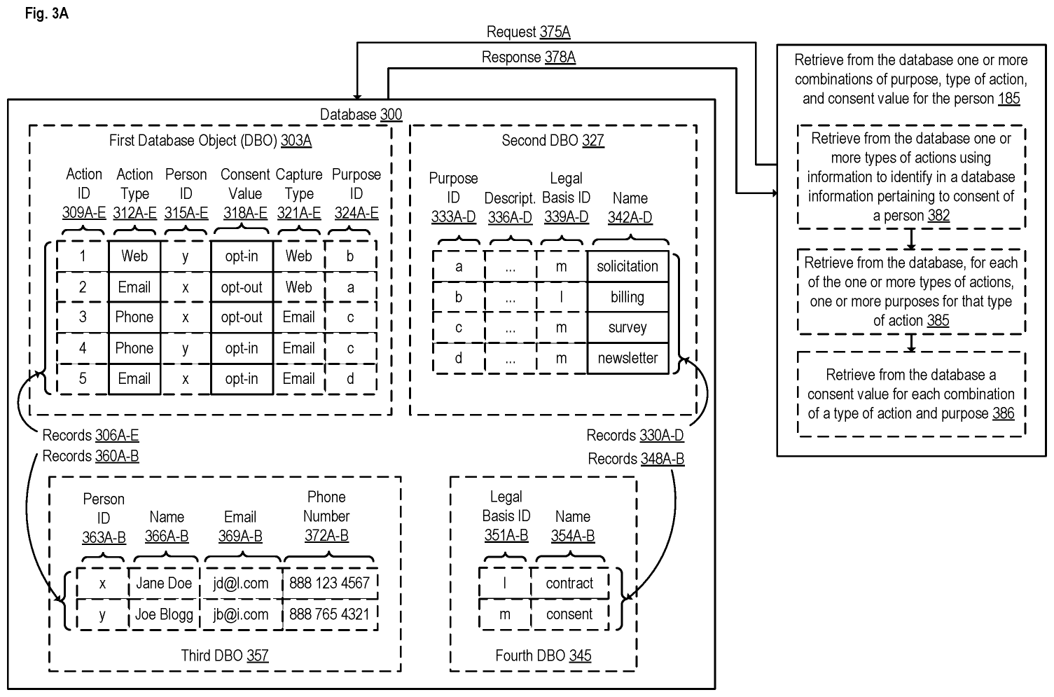

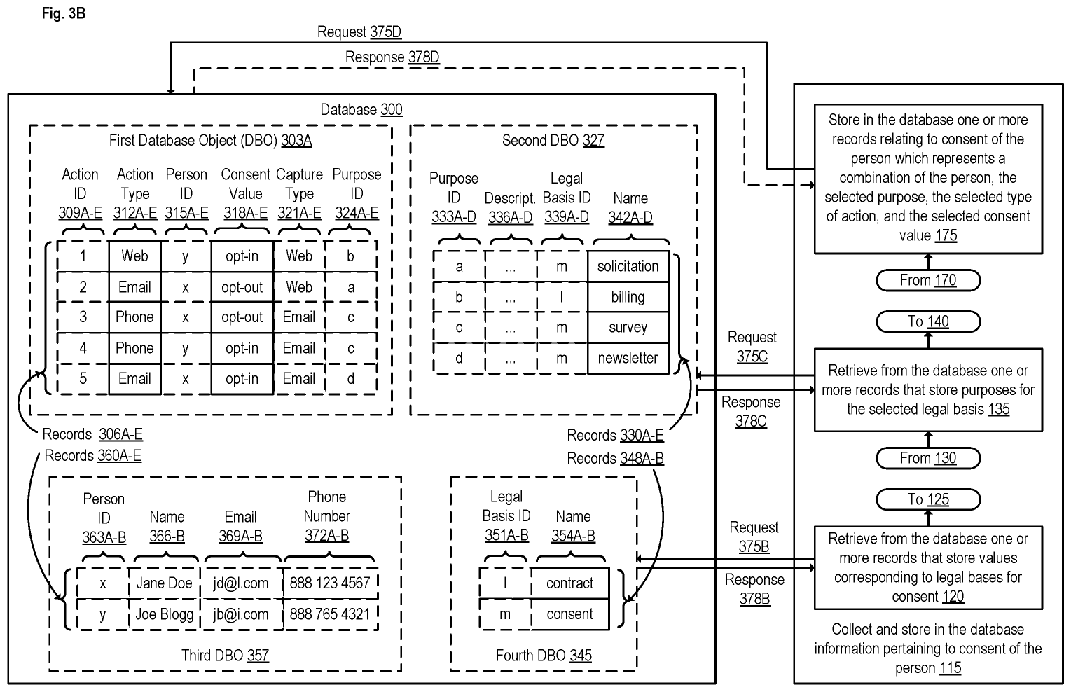

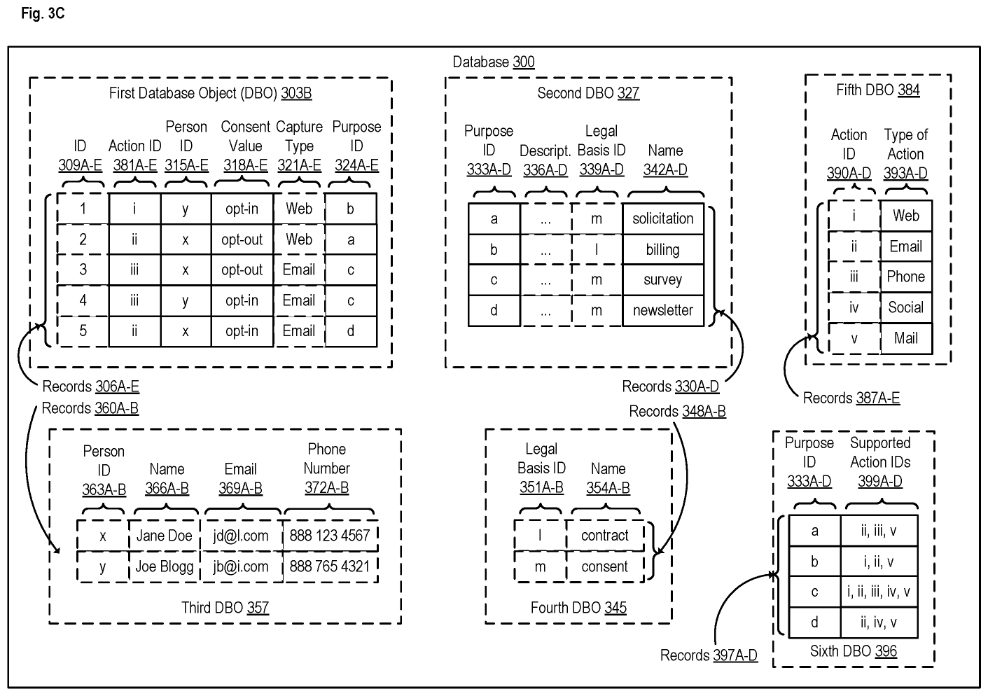

Block 105 includes determining whether a database includes one or more combinations of a purpose, a type of action, and a consent value for the person. Referring to the exemplary database shown in FIG. 3A, block 105 might include querying database 300 to determine whether first DBO 303A includes one or more records that include a given value in the field person ID 315. For example, if the name “Jane Doe” was provided in block 100, block 105 might include querying database 300 1) to determine that record 360A includes the value “x” for person ID 363A; and 2) to determine that first DBO 303A includes one or more records 306 that include the value “x” for person ID 315, where the records 306 each include a corresponding action type 312, purpose ID 324, and consent value 318.

Responsive to determining that a database includes one or more combinations of a purpose, a type of action, and a consent value for the person, flow passes to block 115 which is described later herein. Responsive to determining that the database does not include one or more combinations of a purpose, a type of action, and a consent value for the person, flow passes to block 110. In some implementations, block 105 includes displaying an appropriate message to the user; e.g., that consent information was found for the person, or that consent information was not found for the person (and optionally that the user can collect and store consent information for the person).

Block 110 includes determining whether to display, or to collect and store, information pertaining to consent of the person. In some implementations, block 110 includes receiving an indication from the user (e.g., by the user selecting a navigation button in a UI which presents the user with an option to view the person's consent information and another option to create consent information for the person). In other implementations, block 110 does not include receiving an indication from the user (e.g., the determination is made based on the user's context in a GUI, such as whether the user is in a context of displaying a person's information or in a context of collecting and storing other information pertaining to the person). In yet other implementations, block 110 is not implemented. For example, in one implementation, responsive to determining in block 105 that the database includes one or more combinations of purpose, type of action, and consent value for the person, flow passes from block 105 to block 180.

An alternative implementation shown in FIG. 1B includes block 112 in lieu of block 110. Block 112 includes determining whether to display, or to collect, information pertaining to consent of the person. Responsive to determining in block 112 to display information, flow passes to block 180. Responsive to determining in block 112 to collect information, flow passes to block 117.

From block 110, flow passes to block 180 responsive to determining that information pertaining to consent of the person is to be displayed, whereas flow passes to block 115 responsive to determining that such information is to be collected and stored.

In block 180, information pertaining to consent of the person is displayed. In one implementation, block 180 includes block 185, block 190, block 195, and block 199.

In block 185, one or more combinations of purpose, type of action, and consent value for the person are retrieved from the database. Retrieving the combinations from the database may be performed in different ways. Referring to the example in FIG. 3A, in some implementations, retrieving the combinations from the database may include one or more of blocks 382, 385, and 386, depending on the order of information types according to which the combinations are stored. In block 382, one or more types of actions are retrieved from the database using the information to identify the person's consent information.

In one implementation, block 382 includes submitting a request (e.g., request 375A) to database 300 to retrieve one or more of records 306A-E where the value of person ID 315 corresponds to the information used to identify the person's contact information. For example, for the person with name “Jane Doe,” first DBO 303A is queried for records where person ID 315 has the value “x,” which returns a query result (e.g., response 378A) including record 306B, 306D, and 306E (with action types “Email,” “Phone,” and “Email” respectively). From block 382, flow passes to block 385.

In block 385, one or more purposes for each of the one or more types of action are retrieved from the database. In one implementation supporting the datamodel shown in FIG. 3A, block 385 includes querying second DBO 327 using the values of purpose ID 324 in the records 306 retrieved from first DBO 303A. For example, for the records 306B, 306D, and 306E pertaining to “Jane Doe,” second DBO 327 is queried with the purpose IDs “a,” “c,” and “d,” respectively, which returns a query result including record 330A, 330C, and 330D. In another implementation supporting the datamodel shown in FIG. 3A, the requests of block 382 and block 385 can be combined. For example, in implementations where database 300 supports querying two database objects with one query (e.g., via a join), both first DBO 303A and second DBO 327 can be queried in one query (e.g., by joining first DBO 303A and second DBO 327 on the purpose ID 324 and purpose ID 333). From block 385, flow passes to block 386.

In block 386, a consent value for each combination of a type of action and purpose is retrieved from the database. In one implementation (not shown), consent values are stored in another DBO which can be queried based on the type of action and purpose. In another implementation which supports the datamodel shown in FIG. 3A, the requests of block 382, block 385, and block 386 can be combined. For example, a combination of purpose, type of action, and consent value for a person “Jane Doe” can be retrieved by querying both first and second DBOs as described referring to block 385. If database 300 supports queries expressed in Structured Query Language (SQL), block 382, block 385, and block 386 may be performed in some implementations which support a JOIN clause (e.g., with an SQL query such as “SELECT first_dbo.action_type, second_dbo.name, first_dbo.consent_value FROM first_dbo INNER JOIN second_dbo ON first_dbo.purpose_id=second_dbo.person_id WHERE first_dbo.person_id=′Jane Doe”). Querying database 300 for combinations of type of action, purpose, and consent value for a person “Jane Doe” provides the following combinations: 1) Email, solicitation, opt-out; 2) Phone, survey, opt-out; and 3) Email, newsletter, opt-in.

Displaying Consent Information

Returning to FIG. 1A, flow passes from block 185 to block 190. In block 190, a first UI element is displayed that allows for viewing and selecting from types of actions for the person. Allowing viewing and selecting from types of actions as an information type aids a user interested in performing the action relative to the person. For example, if a user is interested in calling the person, the user can select the type of action “Phone” in the first UI element to view relevant consent information pertaining to the person. Alternatively, if a type of action (e.g., “Phone”) is not shown in the first UI element, the user readily knows that no consent information is available for that action pertaining to the person.

An exemplary first UI element is shown in FIG. 2A. FIG. 2A shows first UI element 200, which can be implemented in different ways. For example, first UI element 200 may be a dialog box, a tile in a dashboard, a panel, etc. As shown in FIG. 2A, first UI element 200 includes a UI element known as an accordion, which includes entries for type of action 205A (“Email”) and optionally for type of action 205B (“Phone”). These entries correspond to the types of actions retrieved from the database in block 185. For example, the “Email” and “Phone” entries shown in first UI element 200 may correspond to the types of actions from the combinations of type of action, purpose, and consent value for “Jane Doe” as previously described.

Optionally, first UI element includes an icon for each type of action 205 (e.g., an envelope icon for “Email” such as icon 210A; a handset icon for “Phone” such as icon 210B; a globe icon for “Web” (not shown); etc.). Including an icon 210 aids a user in rapidly interpreting the information shown in first UI element 200. In some implementations, first UI element 200 also includes text 215 for each type of action 205 (e.g., text 215A for “Email” which reads “You may or may send email to this person based on the following purposes”; and text 215B for “Phone” which reads “You may or may not call this person based on the following purposes”). Optionally, text 215 is customizable for one or more types of actions, and optionally text 215 can be customized to display the name of the person to whom the types of actions pertain rather than “person.” First UI element 200 also includes control 220; e.g., control 220A and control 220B, which are each selectable by a user for a corresponding type of action 205.

Returning to FIG. 1A, from block 190, flow passes to block 195. In block 195, a selected type of action is accepted from the user. For example, referring to FIG. 2A, a user may select a type of action by selecting a control 220A or control 220B (which selects type of action 205A (“Email”) or type of action 205B (“Phone”) respectively). Control 220 can be implemented in other ways; e.g., as a button, a tab, a list, etc., and may be associated with a different UI element than the accordion shown in FIG. 2A, or not associated with a UI element. For example, control 220 may be implemented as a button with a label corresponding to a type of action. In the example shown in FIG. 2A, control 220A and control 220B activate entries of an accordion which respectively correspond to type of action 205A (“Email”) and type of action 205B (“Phone”), thus selecting a respective type of action 205. From block 195, flow passes to block 199.

In block 199, based on the selected type of action, a purpose and an indication of a consent value is displayed in the first UI element respectively for the purpose and the consent value found in each of one or more combinations in the database for the person, purpose, type of action, and consent value information types.

In some implementations, the fourth UI element includes a control that is selectable by the user, and the displaying the purpose and the indication of the consent value respectively for the purpose and the consent value found in each of the one or more combinations is responsive to the user selecting the control. For example, FIG. 2B shows first UI element 200 responsive to the user selecting control 220A; i.e., first UI element 200 with the entry for type of action 205A (“Email”) expanded. Relative to FIG. 2A, FIG. 2B also shows 1) purpose 225A (corresponding to “Newsletter”), text 230A (which reads “You may use the person's data to send the newsletter to the person”), and indication of consent value 235A; and 2) purpose 225B (corresponding to “Solicitation”), text 230B (which reads “You may not use the person's data to send offers to the person”), and indication of consent value 235B. Indication of consent value 235 is a graphical representation of the person's consent for the type of 205 and purpose 225. In some implementations, text 230 is customizable, and/or reflects the indication of consent value 235 for the purpose 225 (e.g., the text may be changed automatically, based on the indication of consent value 235, to reflect whether the person has consented to the type of action 205 and corresponding purpose 225). The purposes 225 shown in FIG. 2B are exemplary and not limiting. Other implementations may use none, some, or all of purposes 225, and/or other purposes (e.g., “Research,” “Referral,” “Customer support,” etc.).

Returning to the example of the consent information for the person “Jane Doe,” the consent information retrieved in block 185 included combinations of type of action, purpose, and consent value of 1) Email, Solicitation, opt-out; 2) Phone, Survey, opt-out; and 3) Email, Newsletter, opt-in. As shown in FIG. 2B, first UI element 200 displays a purpose and an indication of a consent value for these combinations based on the selected type of action (i.e., type of action 205A). Specifically, FIG. 2B shows 1) the indication of consent value 235A is based on a consent value of “opt-in” for type of action “Email” and purpose “Newsletter”; and 2) the indication of consent value 235B is based on a consent value of “opt-out” for type of action “Email” and purpose “Solicitation.”

In some implementations, the indication of consent value 235 is based on a consent value (e.g., “opt-in,” “opt-out,” etc.) and a period of time for which that consent value is valid. For example, implementations may allow a user to select a period of time for which a consent value is valid when collecting consent information pertaining to a person (e.g., as shown in FIG. 2E), and store that period of time together with the consent value. Thus, retrieving the combinations of purpose, type of action, and consent value in block 185 may also include retrieving the period of time for which the consent value is valid, if available. Displaying indication of consent value 235 can account for the consent value's validity (e.g., a tick icon can be displayed based on the consent value being “opt-in” and valid, a cross icon can be displayed based on the consent value being “opt-out” and valid, a cross icon or another icon (e.g., an interrogation mark, “?”) can be displayed based on the consent value being “opt-in” and invalid, etc.). Incorporating a consent value's validity in an indication of consent value 235 improves decisions based on the indication of consent 235. In different implementations, none, some, or all of indications of consent value 235 are based on a consent value and a period of time for which the consent value is valid.

The information displayed in first UI element 200 is according to an order of information types including type of action (i.e., type of action 205), purpose (i.e., purpose 225), and consent (represented by indication of consent value 235). Displaying the information according to this order helps a user navigate and act on the information. For example, a user that is interested in performing the action “Email” relative to the person can select control 220A, which displays a purpose 225 and an indication of a consent value 235 respectively for the purpose and the consent value found in each of one or more combinations retrieved for the person in block 185. The user can then view the purposes to determine whether the person has consented to the type of action 205 for a given purpose of interest by identifying the purpose 225 and viewing the corresponding indication of consent value 235. Thus, the structure, content, and functionality of first UI element 200 facilitates a user viewing and using the consent information that first UI element 200 displays.

In some implementations, block 199 includes displaying a UI element that allows a user to collect and store additional consent information for the user or update the consent information already displayed. For example, in implementations where first UI element is implemented as a UI element (e.g., a screen) of a GUI wizard, a first UI element such as first UI element 200 includes optional UI elements (e.g., buttons) Previous 202 and Next 204. As first UI element 200 is shown in FIGS. 2A and 2B, a user selecting the UI element Previous 202 returns the user to a previous UI element (e.g., to a UI element that allows a user to provide information to identify a person's consent information, that may or may not be a UI element in a GUI wizard). In one implementation, a user selecting the UI element Next 204 in first UI element 200 (as shown in FIGS. 2A and 2B) results in displaying a UI element that allows the user to indicate if consent information for the person is to be modified or additional consent information is to be collected and stored. In implementations which allow a user to collect and store additional consent information for the person, flow passes from block 199 to block 115.

Collecting and Storing Consent Information

In block 115, information pertaining to consent of the person is collected and stored in the database. As described more fully below, in one implementation, the information collected in block 115 is collected according to an order of information types including legal basis, purpose, type of action, and consent.

An alternative implementation shown in FIG. 1B includes block 117 in lieu of block 115. In block 117, information pertaining to consent of a person is collected. The information is collected in an order according to a first order of information types that include legal basis, purpose, type of action, and consent.

Collecting the information according to this order provides certain advantages. For example, first collecting information relating to the legal basis of the consent information allows an organization to implement one or more policies relating to collecting and using consent information, as described further below. Moreover, first collecting information relating to the legal basis of the consent information is often a natural starting point of an interaction with a person who is a customer. For example, a customer service representative or a sales executive might contact an existing customer regarding a contract with that customer (in which case the legal basis of any consent information might be “contract”). For another example, a sales executive might contact a lead to solicit business, and begin by asking whether the lead is interested in hearing more about certain goods or services (in which case the legal basis of any consent information might be “consent”). Likewise, collecting information relating to a purpose for a type of action relative to the person follows naturally after collecting information relating to the legal basis information type. For example, after receiving an affirmative response, the sales executive may discuss the goods or services and seek to qualify the lead by asking whether the sales executive can provide a demonstration, a sample, further marketing material, etc. (in which case the purpose of any consent information might be “solicitation,” “newsletter,” etc.). Further, the sales executive may ask to contact the lead (in which case the type of action, e.g., “phone,” “email,” etc., is then relevant), and the lead's response may reflect consent (e.g., if the lead accepts or rebuffs the sales executive's offer). Thus, collecting consent information according to an order of information types including legal basis, purpose, type of action, and consent may parallel a process in which consent information is obtained. In turn, this can make collecting the consent information to store in the database more intuitive, and/or better suited to real-time or near-time capture.

Block 115 includes block 120. In block 120, one or more records that store values corresponding to legal bases for consent are retrieved from the database. In some implementations, the records that store values corresponding to legal bases for consent are stored in the database by a different user in a role of administrator, and/or the user is not in a role of administrator or otherwise lacks permissions to modify such records. Separating the roles of users in this fashion allows an organization to control how users (e.g., users in non-administrator roles) can collect and store consent information. As described later herein, records that store purposes are associated with one or more records that store values corresponding to legal bases for consent. Thus, defining the legal bases for consent defines in part the purposes that can be selected by a user. Allowing users in administrator roles and disallowing users in non-administrator roles to define the legal bases restricts the purposes that users in non-administrator roles can select when collecting and storing consent information. In turn, this allows an organization to define and implement policy around consent. For example, an organization could define legal bases limited to “contract” (e.g., a person providing consent by contract). In another implementation, an organization could further define and store the purposes for legal bases and disallow users in non-administrator roles from storing same. For example, an organization could define purposes of only billing, customer service, and solicitation for a legal basis of “contract.” Thus, users in non-administrator roles could not collect and store consent information for a person for other purposes for the “contract” legal basis. Again, this allows the organization to tailor its consent management system and policies.

Referring to the exemplary database shown in FIG. 3B, in some implementations, block 120 includes submitting request 375B to database 300. Database 300 includes a fourth DBO 345 that includes records 348A-B. Records 348 store values corresponding to legal bases (i.e., values stored in name 354). In the example shown, the request 375B results in a response 378B including the values “contract” and “consent” for legal bases. The legal basis of “consent” may suggest express consent (e.g., a person manifests consent to a type of action for a purpose, such as by clicking a UI element with text “I agree” on a webpage) and/or implied consent (e.g., a person continues to browse a webpage after being requested to provide consent as a condition to continued browsing). From block 120, flow passes to block 125.

In block 125, a second UI element is displayed that allows the user to select one of the legal bases. For example, the second UI element might display the legal bases “contract” and “consent” retrieved from fourth DBO 345 as discussed in relation to FIG. 3B.

FIG. 2C is a diagram showing an exemplary second UI element 240 that allows a user to select a legal basis and a purpose for the selected legal basis. Specifically, second UI element 240 includes 1) a UI element shown as Contract 245A; 2) another UI element shown as Consent 245B; and 3) text 250 (which reads “What is the legal basis of the consent?”) to prompt the user to make a selection of a UI element 245. UI elements 245 are selectable such that a user can select one of the UI elements 245 (and thus “contract,” “consent,” etc. as a selected legal basis).

Returning to FIG. 1A, from block 125, flow passes to block 130. In block 130, a selection of one of the legal bases is accepted from the user as a selected legal basis. For example, a user might select one of UI elements 245 (e.g., Contract 245A or Consent 245B) and the corresponding legal basis is accepted as the selected legal basis. From block 130, flow passes to block 135.

In block 135, one or more records are retrieved from the database that store purposes for the selected legal basis. In one implementation shown in FIG. 3B, block 135 includes submitting request 375C to second DBO 327 to retrieve one or more of records 330 in response 378C. For example, if the selected legal basis is “consent” (i.e., the value of name 354B), request 375C 1) is for any of records 330 that include a value of “m” (i.e., the value of legal basis ID 351B) in legal basis ID 339, and 2) returns the records 330A, 330C, and 330D. Record 330A is for the purpose “solicitation” (as indicated by the value in name 342A); record 330C is for the purpose “survey” (as indicated by the value in name 342C); and record 330D is for the purpose “newsletter” (as indicated by the value in name 342D). Thus, in some implementations, the database (e.g., database 300) stores data indicating a set of purposes for each of the legal bases. From block 135, flow passes to block 140.

In block 140, one or more of the purposes for the selected legal basis are displayed in the second UI element, wherein the second UI element allows the user to select one of those purposes for the selected legal basis. Referring to FIG. 2C, the exemplary second UI element 240 displays 1) the purposes Solicitation 255A, Survey 255B and Newsletter 255C (corresponding to the legal basis “consent” in second DBO 327 shown in FIG. 3B); and optionally 2) text 260 (which reads “For which purpose would you like to record the person's consent?”) to prompt the user to select a purpose for the selected legal basis. In one implementation, one or more purposes 255 are only displayed after a legal basis is selected (as indicated by the dashed lines around Solicitation 255A, Survey 255B and Newsletter 255C in FIG. 2C); e.g., to avoid confusing the user. These purposes are exemplary and not limiting; other implementations may support some, none, or all of these purposes, and/or different purposes (e.g., customer support, orders, etc.).

Other implementations may provide a different second UI element. For example, possible purposes for all legal bases may initially be displayed in a second UI element in a greyed-out or disabled format, and responsive to a user selection of a legal basis, the purposes for that legal basis are enabled for selection. In yet other implementations, the second UI element may only display UI elements 245 for legal bases (and optionally text 250) initially, and on user selection of one the UI elements 245, the second UI element is replaced with a third UI element that displays the purposes for the selected legal basis (e.g., a UI wizard that shows the second UI element advances to a next UI element). From block 140, flow passes to block 145.

In block 145, a selected purpose is accepted from the user. For example, a user may select one of the purposes 255 shown in FIG. 2B. From block 145, flow passes to block 150.

In block 150, a third UI element is displayed that allows the user to select a type of action from types of actions for the selected purpose. For example, implementations may display a third UI element such as the exemplary third UI element 270 shown in FIG. 2D. Third UI element 270 includes text 273 (which reads “What type of action does the consent relate to?”), which may prompt the user to make a selection of a type of action through one of UI elements 275. Third UI element 270 also includes the following UI elements: Email 275A, Web 275B, Phone 275C, Social 275D, and Mail 275E, each of which is selectable by the user and corresponds to a type of action (i.e., email, web, phone, social, and mail) These types of actions are exemplary and not limiting; other implementations may support some, none, or all of these types of actions, and/or different types of actions (e.g., short message service (SMS), tracking, fax, profiling, etc.).

In some implementation, the types of actions are not retrieved from the database (e.g., the types of actions are hardcoded, provided in a configuration file, etc.). Implementations might provide all available types of actions regardless of the selected purpose (i.e., the types of actions for the selected purpose are all the types of actions available in the system) or provide certain ones of available types of actions based on the selected purpose. For example, an implementation might provide the types of actions “Email,” “Web,” “Phone,” “Social,” “Mail,” etc. regardless whether the selected purpose is “Solicitation,” “Survey,” or “Newsletter.” Alternatively, an implementation might provide only certain of those types of actions for certain of the purposes (e.g., an implementation might not provide the type of action “Phone” if the selected purpose is “Newsletter”).

In other implementations, the types of actions are retrieved from the database. For example, referring to the exemplary datamodel in FIG. 3C, types of actions are retrieved from fifth DBO 384, which includes records 387. These types of actions are retrieved regardless of the selected purpose in one implementation. Alternatively, types of actions are retrieved from sixth DBO 396 corresponding to the selected purpose. Each of records 397 in sixth DBO 396 includes a purpose ID 333 and supported action IDs 399. Thus, if the selected purpose is “Solicitation” (i.e., name 342A of record 330A), types of actions are retrieved by 1) retrieving a record which includes a value of “a” (i.e., the value of purpose ID 333A of record 330A) from sixth DBO 396 (i.e., record 397A); and 2) retrieving the types of actions 393 from fifth DBO 384 which include an action ID 390 that is included in that record (i.e., which include an action ID with value “ii,” “iii,” or “v,” which respectively correspond to “Email,” “Phone,” and “Mail” in type of action 393B, type of action 393C, and type of action 393E). From block 150, flow passes to block 155.

In block 155, a selected type of action for a combination of the person and the selected purpose is accepted from the user. For example, a selected type of action is accepted from third UI element 270 shown in FIG. 2D responsive to the user selecting a type of action through a UI element 275. In one implementation, a user may select one or more than one type of action in the third UI element and those selected types of actions accepted in block 155. From block 155, flow passes to block 160.

In block 160, a fourth UI element is displayed that allows the user to select from consent values for the combination of the person, the selected purpose, and the selected type of action. For example, a fourth UI element, such as fourth UI element 280 shown in FIG. 2E, is displayed. Fourth UI element 280 includes text 290 which reads “What is the person's indication of consent?” which may prompt a user to select one of consent values through UI elements 283. UI elements 283 include UI elements Opt In 283A and Opt Out 283B; and optionally Seen 283C and Unseen 283D, which are each selectable by a user. UI elements 283 and the corresponding consent values are exemplary and not limiting. An implementation may use none, some, or all of UI elements 283 and/or the corresponding consent values, and/or other UI elements and corresponding consent values (e.g., “explicit opt-in,” “explicit opt-out,” “implicit opt-in,” “implicit opt-out,” “unknown,” etc.).

Block 160 optionally includes block 163. In block 163, the fourth UI element allows the user to select a period of time for which the consent value is valid. As mentioned, a person may provide consent or deny consent for a definite or indefinite period of time (e.g., for one week, one month, one year, the duration of a legal relationship, until consent is provided or revoked, etc.). FIG. 2E shows an exemplary fourth UI element that allows the user to select a period of time for which a consent value is valid. Fourth UI element 280 optionally includes text 287A (which reads “For how long is this consent valid?”) and UI element 285. UI element 285 is implemented as a slider as shown in FIG. 2E; i.e., a user may position the circle along the horizontal line to set a period of time (e.g., from 0 to 24 months as text 287B indicates) for which a consent value is valid. Other implementations capture the period of time differently (e.g., using a datepicker UI element to input a start and/or end date, allowing a user to manually input a start and/or end date, etc.). Implementations which allow a user to select a period of time for which the consent value is valid provide finer granularity in consent information. In turn, an organization can make better-informed decisions based on that information. From block 160, flow passes to block 165.

In block 165, a selected consent value is accepted from the user for the combination of the person, the selected purpose, and the selected type of action. From block 165, flow passes to block 170.

In block 170, a fifth UI element is displayed that allows the user to provide information relating to how the selected consent value was obtained. Information relating to how the consent value was obtained may be useful for purposes including record keeping, compliance, establishing a chain of custody for consent information, etc. Information that may be relevant can include 1) when the indication of consent was received; 2) how the information was received; 3) the identities of any people involved in obtaining and storing the consent information, etc. Capturing information relating to how the consent value was obtained may be mandated by an organization's legal department or privacy team. Thus, block 170 might facilitate implementing an organization's policy around consent information capture. In one implementation, responsive to accepting information from the user relating to how the selected consent value was obtained, the information is stored in the database.

FIG. 2F shows a fifth user interface element 292 that allows a user to provide information relating to how a selected consent value was obtained, according to some exemplary implementations. Fifth UI element 292 includes text 296 (which reads “How did you acquire the consent?”) to prompt the user in selecting one of UI elements 295 which each specify an option for how consent information was obtained; e.g., Email 295A, Phone 295B, Web 295C, Social 295D, and Mail 295E. These options are exemplary and not limiting. A fifth UI element may include none, some, or all of UI elements 295, and/or others (e.g., “In Person,” “SMS,” “Contract,” etc.). In the exemplary fifth UI element shown in FIG. 2F, each of UI elements 295 is selectable by the user. Fifth UI element 292 also include text 299 (which reads “What were the circumstances?”) to prompt the user to enter information in UI element 297. In one implementation, UI element 297 is a text field in which the user can enter text. For example, the user may specify an email address of the organization to which an indication of consent was sent (e.g., an email that indicates that the person wishes to unsubscribe from future emails); a service center phone number that the person called and/or information identifying a customer service representative who took the call; a uniform resource locator (URL) of a website from which consent information was received from the user; etc. Other implementations may include different elements in fifth UI element 292. For example, an implementation may include other UI elements to capture structured data (e.g., dates and/or times relating to how consent information was obtained, identifiers for one or more employees who were involved, etc.). In some implementations, responsive to a user entering information in fifth UI element 292 (e.g., selecting one of UI elements 295, and/or information in UI element 292) or another trigger (e.g., a user selecting Next 204), the information is stored in the database and associated with the consent information obtained. For example, information relating to how consent was acquired from one of UI elements 295 may be stored in capture type 321 of first DBO 303 (shown in FIGS. 3B and 3C). From block 170, flow passes to block 175.

In block 175, one or more records relating to consent of the person which represents a combination of the person, the selected purpose, the selected type of action, and the selected consent value are stored in the database. As described referring to FIG. 1A, the information collected in block 115 is collected according to an order of information types including legal basis, purpose, type of action, and consent. Collecting consent information according to this order provides certain advantages. However, the information need not be stored according to the same order. Different implementations may store the one or more records differently.

As shown in FIG. 3B, block 175 includes submitting request 375D according to some exemplary implementations, and optionally receiving response 378D (e.g., a value indicating whether the request 375D was performed successfully). The datamodel of database 300 is such that 1) first DBO 303A stores records that include a type of action (action type 312), information to identify the person (person ID 315), and a consent value (consent value 318); 2) second DBO 327 stores records that include a purpose (name 342). Thus, storing the one or more records relating to consent of the person in database 300 includes 1) inserting a record in first DBO 303A that includes the person, the selected type of action, and the selected consent value of the combination and 2) inserting a record in second DBO 327 that includes the selected purpose of the combination representing the consent of the person. One potential advantage of this approach is that the type of action and consent value can be retrieved by querying one database object (e.g., first DBO 303A), which may favor query performance Favoring query performance is beneficial in some implementations (e.g., ones which support a relatively high volume of queries for consent information).

Other implementations may store the information for the information types differently. For example, database 300 as shown in FIG. 3C includes fifth DBO 384. Fifth DBO 384 includes the type of action (type of action 393), which is referenced by ID (action ID 390) in first DBO 303B (action ID 381). In this example, retrieving consent information includes dereferencing the action ID, and thus might be slower than otherwise. However, first DBO 303B might be more compressible and thus have reduced size. As one of skill in the art will recognize, other datamodels are also possible (e.g., a denormalized datamodel where information for each of the information types person, purpose, type of action, and consent value is stored in a single database object, a normalized datamodel, etc.), reflecting different modalities for storing consent information, and with different potential trade-offs and benefits.

Example Electronic Devices and Environments

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices (also referred to as devices) are designed for and/or used for a variety of purposes, and different terms may reflect those purposes (e.g., user devices, network devices). Some user devices are designed to mainly be operated as servers (sometime referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, etc.). The software executed to operate a user device (typically a server device) as a server may be referred to as server software or server code), while the software executed to operate a user device (typically a client device) as a client may be referred to as client software or client code. A server provides one or more services to (also referred to as serves) one or more clients.

The term “user” refers to an entity (e.g., an individual person) that uses an electronic device, and software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

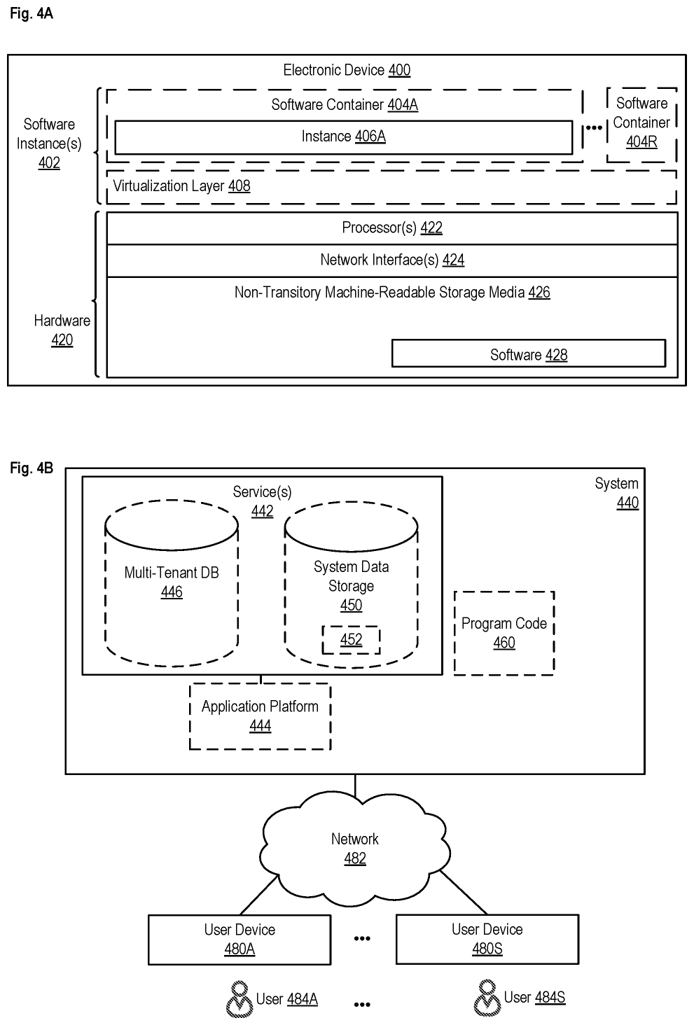

FIG. 4A is a block diagram illustrating an electronic device 400 according to some example implementations. FIG. 4A includes hardware 420 comprising a set of one or more processor(s) 422, a set of one or more network interfaces 424 (wireless and/or wired), and non-transitory machine-readable storage media 426 having stored therein software 428 (which includes instructions executable by the set of one or more processor(s) 422). Each of the previously described clients and the consent capture service may be implemented in one or more electronic devices 400. In one implementation, one or more of block 100, block 105, block 110, block 180, and/or block 115 (and one or blocks included therein) can be part of the consent capture service. In some implementations, the consent capture service may include a database which stores information pertaining to consent of a person (e.g., database 300). In one implementation, the consent capture service is available to one or more clients (e.g., a GUI). In one implementation: 1) each of the clients is implemented in a separate one of the electronic devices 400 (e.g., in end user devices where the software 428 represents the software to implement clients to interface directly and/or indirectly with the consent capture service (e.g., software 428 represents a web browser, a native client, a portal, a command-line interface, and/or an application programming interface (API) based upon protocols such as Simple Object Access Protocol (SOAP), Representational State Transfer (REST), etc.)); 2) the consent capture service is implemented in a separate set of one or more of the electronic devices 400 (e.g., a set of one or more server devices where the software 428 represents the software to implement the consent capture service); and 3) in operation, the electronic devices implementing the clients and the consent capture service would be communicatively coupled (e.g., by a network) and would establish between them (or through one or more other layers and/or or other services) connections for submitting data (e.g., from one or more user interface devices) to the consent capture service and returning data (e.g., one or more status values) to the clients. Other configurations of electronic devices may be used in other implementations (e.g., an implementation in which the client and the consent capture service are implemented on a single electronic device 400).

During operation an instance of the software 428 (illustrated as instance 406A and also referred to as a software instance; and in the more specific case of an application, as an application instance) is executed. In electronic devices that use compute virtualization, the set of one or more processor(s) 422 typically execute software to instantiate a virtualization layer 408 and software container(s) 404A-R (e.g., with operating system-level virtualization, the virtualization layer 408 may represent a container engine (such as Docker Engine by Docker, Inc. or rkt in Container Linux by Red Hat, Inc.) running on top of (or integrated into) an operating system, and it allows for the creation of multiple software containers 404A-R (representing separate user space instances and also called virtualization engines, virtual private servers, or jails) that may each be used to execute a set of one or more applications; with full virtualization, the virtualization layer 408 represents a hypervisor (sometimes referred to as a virtual machine monitor (VMM)) or a hypervisor executing on top of a host operating system, and the software containers 404A-R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation an instance of the software 428 is executed within the software container 404A on the virtualization layer 408. In electronic devices where compute virtualization is not used, the instance 406A on top of a host operating system is executed on the “bare metal” electronic device 400. The instantiation of the instance 406A, as well as the virtualization layer 408 and software containers 404A-R if implemented, are collectively referred to as software instance(s) 402.

Alternative implementations of an electronic device may have numerous variations from that described above. For example, customized hardware and/or accelerators might also be used in an electronic device.

Example Environment

FIG. 4B is a block diagram of a deployment environment according to some example implementations. A system 440 includes hardware (e.g, a set of one or more server devices) and software to provide service(s) 442, including the consent capture service. In some implementations the system 440 is in one or more datacenter(s). These datacenter(s) may be: 1) first party datacenter(s), which are datacenter(s) owned and/or operated by the same entity that provides and/or operates some or all of the software that provides the service(s) 442; and/or 2) third party datacenter(s), which are datacenter(s) owned and/or operated by one or more different entities than the entity that provides the service(s) 442 (e.g., the different entities may host some or all of the software provided and/or operated by the entity that provides the service(s) 442). For example, third party datacenters may be owned and/or operated by entities providing public cloud services (e.g., Amazon.com, Inc. (Amazon Web Services), Google LLC (Google Cloud Platform), Microsoft Corporation (Azure)).

The system 440 is coupled to user devices 480A-S over a network 482. The service(s) 442 may be on-demand services that are made available to one or more of the users 484A-S working for one or more entities other than the entity which owns and/or operates the on-demand services (those users sometimes referred to as outside users) so that those entities need not be concerned with building and/or maintaining a system, but instead may make use of the service(s) 442 when needed (e.g., when needed by the users 484A-S). The service(s) 442 may communicate with each other and/or with one or more of the user devices 480A-S via one or more APIs (e.g., a REST API). The user devices 480A-S are operated by users 484A-S.

In some implementations the system 440 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 440 is a multi-tenant cloud computing architecture supporting multiple services, such as one or more of the following:

| Type of Service | Example Service(s) by salesforce.com, inc. |
|---|---|
| Customer relationship management (CRM) | Sales Cloud, consent capture service |
| Configure, price, quote (CPQ) | CPQ and Billing |
| Business process modeling (BPM) | Process Builder |
| Customer support | Service Cloud, Field Service Lightning |
| Marketing | Commerce Cloud Digital, Commerce Cloud |
| | Order Management, Commerce Cloud Store |
| External data connectivity | Salesforce Connect |
| Productivity | Quip |
| Database-as-a-Service | Database.com ™ |
| Data-as-a-Service (DAAS or DaaS) | Data.com |
| Platform-as-a-service (PAAS or PaaS) | Heroku ™ Enterprise, Thunder, Force.com ®, |
| | Lightning |
| Infrastructure-as-a-Service (IAAS or IaaS) | |
| (e.g., virtual machines, servers, and/or | |
| storage) | |
| Analytics | Einstein Analytics, Sales Analytics, Service |
| | Analytics |
| Community | Community Cloud, Chatter |
| Internet-of-Things (IoT) | Salesforce IoT, IoT Cloud |
| Industry-specific | Financial Services Cloud, Health Cloud |
| Artificial intelligence (AI) | Einstein |
| Application marketplace (“app store”) | AppExchange, AppExchange Store Builder |
| Data modeling | Schema Builder |
| Security | Salesforce Shield |
| Identity and access management (IAM) | Field Audit Trail, Platform Encryption, IT |
| | Governance, Access Management, Salesforce |
| | Identity, Salesforce Authenticator |

For example, system 440 may include an application platform 444 that enables PAAS for creating, managing, and executing one or more applications developed by the provider of the application platform 444, users accessing the system 440 via one or more of user electronic devices 480A-S, or third-party application developers accessing the system 440 via one or more of user electronic devices 480A-S.

In some implementations, one or more of the service(s) 442 may use one or more multi-tenant databases 446, as well as system data storage 450 for system data 452 accessible to system 440. In certain implementations, the system 440 includes a set of one or more servers that are running on server electronic devices and that are configured to handle requests for any authorized user associated with any tenant (there is no server affinity for a user and/or tenant to a specific server). The user electronic device 480A-S communicate with the server(s) of system 440 to request and update tenant-level data and system-level data hosted by system 440, and in response the system 440 (e.g., one or more servers in system 440) automatically may generate one or more Structured Query Language (SQL) statements (e.g., one or more SQL queries) that are designed to access the desired information from the one or more multi-tenant database 446 and/or system data storage 450.

In some implementations, the service(s) 442 are implemented using virtual applications dynamically created at run time responsive to queries from the user electronic devices 480A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 460 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 444 includes an application setup mechanism that supports application developers' creation and management of applications, which may be saved as metadata by save routines. Invocations to such applications, including the consent capture service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 482 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 440 and the user electronic devices 480A-S.

Each user electronic device 480A-S (such as a desktop personal computer, workstation, laptop, Personal Digital Assistant (PDA), smart phone, augmented reality (AR) devices, virtual reality (VR) devices, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 440. For example, the user interface device can be used to access data and applications hosted by system 440, and to perform searches on stored data, and otherwise allow a user 484 to interact with various GUI pages that may be presented to a user 484. User electronic devices 480A-S might communicate with system 440 using TCP/IP (Transfer Control Protocol and Internet Protocol) and, at a higher network level, use other networking protocols to communicate, such as Hypertext Transfer Protocol (HTTP), Andrew File System (AFS), Wireless Application Protocol (WAP), File Transfer Protocol (FTP), Network File System (NFS), an API based upon protocols such as SOAP, REST, etc. In an example where HTTP is used, one or more user electronic devices 480A-S might include an HTTP client, commonly referred to as a “browser,” for sending and receiving HTTP messages to and from server(s) of system 440, thus allowing users 484 of the user electronic device 480A-S to access, process and view information, pages and applications available to it from system 440 over network 482.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method for a computer to collect and display information pertaining to consent of a person through a graphical user interface, the method comprising:
collecting the information in an order according to a first order of information types that include legal basis, purpose, type of action, and consent, the collecting the information comprising:
retrieving, from a database, one or more records that store one or more values corresponding to one or more legal bases for consent;
accepting from a user through a first user interface (UI) element a selection of a legal basis;
retrieving, from the database, one or more records that store one or more purposes for the selected legal basis;
accepting from the user through the first UI element a selection of a first purpose for the selected legal basis;
accepting from the user through a second UI element a selection of a first type of action from a plurality of types of actions for a combination of the person and the selected first purpose;
accepting from the user through a third UI element a selection of a first consent value from a plurality of consent values for the combination of the person, the selected first purpose, and the selected first type of action; and
displaying, according to a second order of information types that include type of action, purpose, and consent, less than all the information, the displaying comprising:
accepting from the user through a fourth UI element a selection of a second type of action; and
displaying in the fourth UI element, based on the selected second type of action, a purpose and an indication of a consent value respectively for the purpose and the consent value found in each of one or more combinations in the database for the person, purpose, type of action, and consent value information types.

2. The method of claim 1, the method further comprising:
displaying the first UI element, wherein the first UI element displays, and allows the user to select from, the one or more legal bases for consent;
displaying, in the first UI element, the one or more purposes for the selected legal basis, wherein the first UI element allows the user to select from the one or more purposes for the selected legal basis;
displaying the second UI element, wherein the second UI element displays, and allows the user to select from, the plurality of types of actions for the combination of the person and the selected first purpose;
displaying the third UI element, wherein the third UI element displays, and allows the user to select from, the plurality of consent values; and
displaying the fourth UI element, wherein the fourth UI element displays, and allows the user to select from, the plurality of types of actions.

3. The method of claim 1, the method further comprising:
storing, in the database, one or more records relating to consent of the person which represents a combination of the person, the selected first purpose, the selected first type of action, and the selected first consent value.

4. The method of claim 3, the method further comprising:
accepting from the user through the third UI element a selection of a period of time for which the selected first consent value is valid; and
storing, in the database, the selected period of time.

5. The method of claim 4, wherein the indication of the consent value for the consent value found in each of the one or more combinations is based on that consent value and another period of time for which that consent value is valid.

6. The method of claim 1, wherein the fourth UI element includes a control that is selectable by the user, and wherein the displaying the purpose and the indication of the consent value respectively for the purpose and the consent value found in each of the one or more combinations is responsive to the user selecting the control.

7. The method of claim 1, further comprising:
displaying a fifth UI element that allows the user to provide information relating to how the selected first consent value was obtained;
accepting, from the user, information relating to how the selected first consent value was obtained as provided information; and
storing the provided information in the database.

8. The method of claim 1, wherein the one or more records that store one or more values corresponding to one or more legal bases for consent were stored in the database by another user in a role of administrator, and wherein the user is not in the role of administrator.

9. A non-transitory machine-readable storage medium that stores instructions that, when executed by a processor, are capable of causing the processor to perform operations to collect and display information pertaining to consent of a person through a graphical user interface, the operations comprising:
collecting the information in an order according to a first order of information types that include legal basis, purpose, type of action, and consent, the collecting the information comprising:
retrieving, from a database, one or more records that store one or more values corresponding to one or more legal bases for consent;
accepting from a user through a first user interface (UI) element a selection of a legal basis;
retrieving, from the database, one or more records that store one or more purposes for the selected legal basis;
accepting from the user through the first UI element a selection of a first purpose for the selected legal basis;
accepting from the user through a second UI element a selection of a first type of action from a plurality of types of actions for a combination of the person and the selected first purpose;
accepting from the user through a third UI element a selection of a first consent value from a plurality of consent values for the combination of the person, the selected first purpose, and the selected first type of action; and
displaying, according to a second order of information types that include type of action, purpose, and consent, less than all the information, the displaying comprising:
accepting from the user through a fourth UI element a selection of a second type of action; and
displaying in the fourth UI element, based on the selected second type of action, a purpose and an indication of a consent value respectively for the purpose and the consent value found in each of one or more combinations in the database for the person, purpose, type of action, and consent value information types.

10. The non-transitory machine-readable storage medium of claim 9, wherein the non-transitory machine-readable storage medium further includes instructions that, when executed by the processor, are capable of causing the processor to further perform operations comprising:
displaying the first UI element, wherein the first UI element displays, and allows the user to select from, the one or more legal bases for consent;
displaying, in the first UI element, the one or more purposes for the selected legal basis, wherein the first UI element allows the user to select from the one or more purposes for the selected legal basis;
displaying the second UI element, wherein the second UI element displays, and allows the user to select from, the plurality of types of actions for the combination of the person and the selected first purpose;
displaying the third UI element, wherein the third UI element displays, and allows the user to select from, the plurality of consent values; and
displaying the fourth UI element, wherein the fourth UI element displays, and allows the user to select from, the plurality of types of actions.

11. The non-transitory machine-readable storage medium of claim 9, wherein the non-transitory machine-readable storage medium further includes instructions that, when executed by the processor, are capable of causing the processor to further perform operations comprising:
storing, in the database, one or more records relating to consent of the person which represents a combination of the person, the selected first purpose, the selected first type of action, and the selected first consent value.

12. The non-transitory machine-readable storage medium of claim 11, wherein the non-transitory machine-readable storage medium further includes instructions that, when executed by the processor, are capable of causing the processor to further perform operations comprising:
accepting from the user through the third UI element a selection of a period of time for which the selected first consent value is valid; and
storing, in the database, the selected period of time.

13. The non-transitory machine-readable storage medium of claim 12, wherein the indication of the consent value for the consent value found in each of the one or more combinations is based on that consent value and another period of time for which that consent value is valid.

14. The non-transitory machine-readable storage medium of claim 9, wherein the fourth UI element includes a control that is selectable by the user, and wherein the displaying the purpose and the indication of the consent value respectively for the purpose and the consent value found in each of the one or more combinations is responsive to the user selecting the control.

15. The non-transitory machine-readable storage medium of claim 9, wherein the non-transitory machine-readable storage medium further includes instructions that, when executed by the processor, are capable of causing the processor to further perform operations comprising:
displaying a fifth UI element that allows the user to provide information relating to how the selected first consent value was obtained;
accepting, from the user, information relating to how the selected first consent value was obtained as provided information; and
storing the provided information in the database.

16. The non-transitory machine-readable storage medium of claim 9, wherein the one or more records that store one or more values corresponding to one or more legal bases for consent were stored in the database by another user in a role of administrator, and wherein the user is not in the role of administrator.
